(19) United States
(12) Patent Application Publication
(10) Pub. No.: US 2002/0192447 A1
(43) Pub. Date: Dec. 19, 2002

(54) Method for setting a process for the manufacture of sealing seams

(76) Inventors: Gunter Schubert, Rheinbach (DE); Michael Lennarz, Bonn (DE); Bruno Broich, Grevenbroich (DE); Guy Boiron, Wintzenheim (FR); Alfred Koblischek, Kappel (DE); Marco Razeti, Padova (IT)

Correspondence Address: FISH & NEAVE, 1251 AVENUE OF THE AMERICAS, 50TH FLOOR, NEW YORK, NY, 10020-1105, US

(21) Appl. No.: 10/053,773

(22) Filed: Jan. 22, 2002

(30) Foreign Application Priority Data
Jan. 22, 2001 (DE) 10102798.2-27

(51) Int. Cl. B32B 7/02

(52) U.S. Cl. 428/216

(57) ABSTRACT

The invention relates to a method for setting the process for the manufacture of sealing seams, in which the interface temperature at the interface between the sealing partners is measured using a temperature-measuring element. It was shown that setting the process based on the course of time of the interface temperature during and after heat input during the sealing makes it possible to optimize the machining parameters to achieve the best possible sealing seam quality, shortest possible machining time and lowest possible energy outlay.

The invention relates to a method for setting a process for the manufacture of sealing seams, in which the interface temperature at the interface between the sealing partners is measured using a temperature-measuring element.

Sealing seams are used extensively to manufacture food packaging, e.g., for closing food packages. For example, a cover, e.g., made out of an aluminum-plastic laminate, paper-plastic laminate or plastic laminate, is used to seal the opening of milk product containers. So-called stand-up-pouches are also manufactured or closed by sealing the pouch material. In addition, sealing seams are also used in other areas to bond so-called sealing partners.

The sealing heat or sealing energy required to manufacture the sealing seam is introduced via the direct introduction of heat during so-called hot sealing, ultrasound coupling or inductive coupling in the sealing area, for example.

During the manufacture of sealing seams, essentially three requirements must be satisfied. First, the machining time for manufacturing the sealing seam must be kept as short as possible. Second, sealing seam must tightly closes the junction point. Finally, the sealing seam is to exhibit a sufficient strength to withstand a load on the sealing partners, e.g., during the transport and storage of sealed containers; however, the bond must not be so strong as to prevent an intended opening without any excessive application of force.

A sealing seam that satisfies the above requirements is manufactured by setting the time-temperature-pressure progression in a suitable manner during pressing on the sealing tools. Known to this end from the article “Heat Sealing of Semi-crystalline Polymer Films”, Journal of Applied Polymer Science, Vol. 51, 89-103 (1994) is to measure the interface temperature at the interface between the sealing partners by means of a temperature measuring element, e.g., a thermocouple, during heat input, to determine whether the melting temperature of at least one sealing layer of the sealing partners is exceeded during heat input. In addition, prior art describes a theoretical model that makes it possible to calculate the interface temperature progression assisted by electronic data processing.

This known procedure for setting the time-temperature-pressure progression during sealing is problematical viewed from various standpoints. On the one hand, the described procedure can only be used to determine whether the melting temperature has been exceeded at the interface, while only very limited, if any, conclusions can be drawn about the extent to which the sealing layers were melted on.

In addition to the requirements described above on the quality of the sealing seams, the point in time at which the sealing seam has been cooled after heat input to the point where it can be loaded is also of great importance to the process for the manufacture of sealing seams. This is particularly important, since for example cups into which milk products are filled can be loaded immediate after sealed, or subjected to a tightness check. During such a tightness check, the cup is usually subjected to pressure, and monitored to see whether the elevated pressure lifts the cover in the cup, i.e., whether the cup is tight. The load is here selected in such a way that the tightness check does not result in leakages or other damages to intact sealing seams, since the sealing layers might not have been completely hardened yet. On the other hand, production-related reasons dictate that the tightness check be conducted as soon as possible after heat input. To this end, prior art has only described taking off the cover after heat input, and measuring the forces necessary to this end during cooling to solidification over the time and/or the removal length, in order to determine the so-called “hot-tack” time at which the sealing layers have solidified sufficiently to enable a nondestructive tightness check.

Proceeding from the prior art described above, the object of the present invention is to indicate a method for setting a process for the manufacture of sealing seams, with which the process parameters are set in such a way that the manufactured sealing seams easily satisfy all quality requirements and enable a better quality control.

According to the invention, the object derived and described above is solved by virtue of the fact that the process is set based on the course of time of the interface temperature during and after heat input during the sealing. This invention is based on the knowledge that a synopsis of the course of time of the interface temperature during and after heat input can provide helpful clues for setting the process. This makes it possible to set the machining parameters in such a way as to ensure a time and cost-optimized manufacture and quality control of sealing seams.

Because the time temperature pressure progression during heat input is set according to the invention based on the course of time of the interface temperature during and after heat input in a first embodiment, an optimal quality of the hot-sealing seams can be ensured in as short a time as possible and at an optimized energy outlay taking into account the requirements mentioned at the outset.

As an alternative or in addition to the embodiment just described, the procedure according to the invention is further developed by setting the time for the tightness check and/or mechanical loadability after heat input. The possibility for exactly ascertaining the so-called “hot-tack” time from the progression of the interface temperature before and after heat input makes it possible to fix the optimal time for a first mechanical load or for the execution of a nondestructive tightness check.

One of the basic preconditions for manufacturing a hot-sealing seam is ensured when setting the process by monitoring when the melting temperature of at least one sealing layer of the sealing partners is exceeded by the interface temperature during heat input.

A measure for the degree of sealing partner melting at the interface is obtained by determining the integral of the time-temperature progression of the interface temperature between the point where the temperature exceeds the melting temperature and falls below the solidification temperature of at least one sealing layer of the sealing partners. The larger the integral, the more extensively the sealing layers of the sealing partners are melted on. Consequently, an evaluation of the integral makes it possible to set the pull to open force required to open the sealing seam, or determine a minimum strength over a minimum surface of the integral.

The so-called “hot-tack” time after which a nondestructive tightness check is possible, for example, can be determined by virtue of the fact that the point at which the temperature falls below the melting temperature of at least one sealing layer of the sealing partners is determined by the interface temperature.

In the majority of materials used for manufacturing a sealing layer, when the sealing layer cools down from a temperature of above the melting temperature to a temperature below the melting temperature, a recrystallization takes place, which in turn releases heat that becomes noticeable during the course of time of the interface temperature after heat input in a temporary reduction in the cooling rate. In another embodiment of the invention, if a recrystallization of at least one sealing layer is determined from a reduction in the cooling rate after heat input is complete, it can be determined from this that the sealing layers have at least partially melted on, regardless of the temperature exceeding the melting temperature. The extent of the reduction in cooling rate or the delay in cooling provides information as to the extent the sealing layers have been melted on for sealing seams having crystalline shares.

The fact that recrystallization takes place after melting on of a sealing layer can be utilized by determining the recrystallization time and deriving information from this as to whether the so-called “hot-tack” time has been reached.

There are numerous ways in which to design and further develop the procedure according to the invention. To this end, for example, reference is made to the claims following claim 1, and also to the description of an embodiment in conjunction with the drawing. The drawing shows:

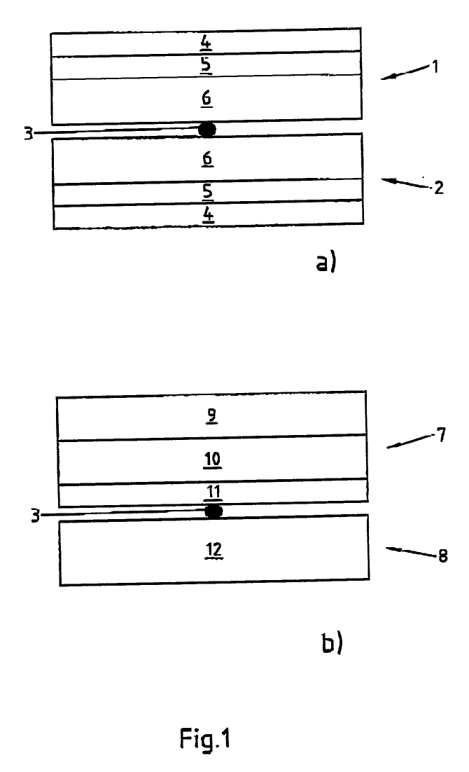

FIG. 1a, b) A diagrammatic view of the structure of the sealing partners before sealing based on two embodiments;

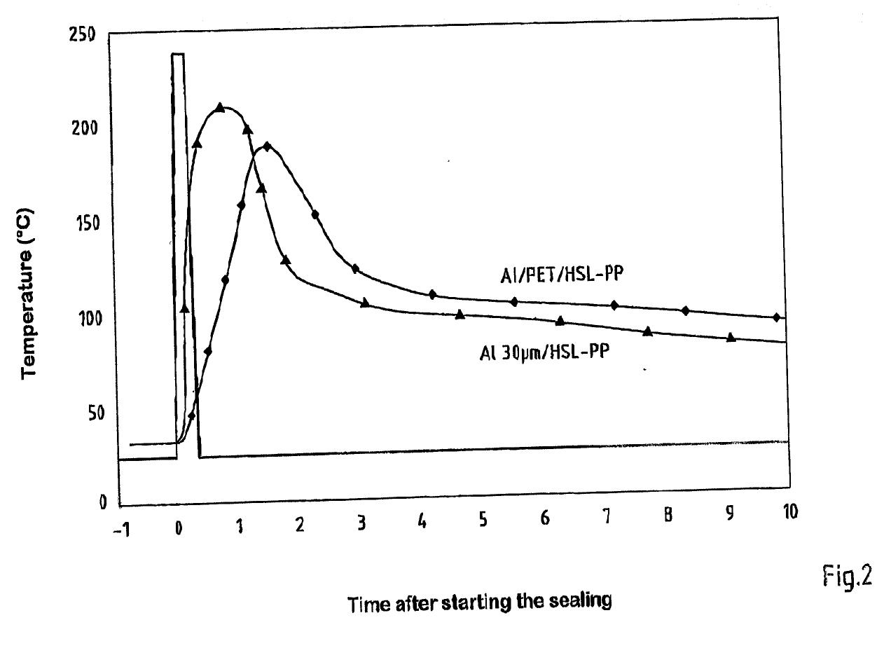

FIG. 2 The time-temperature progression of the interface temperature for two embodiments of sealing bonds, and

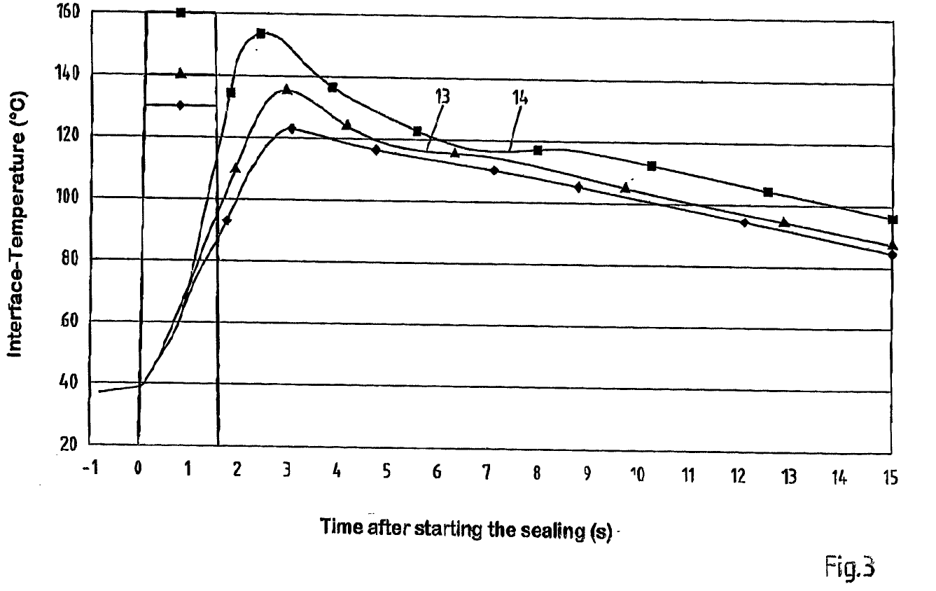

FIG. 3 The time-temperature progression of the interface temperature for another embodiment of a sealing bond and different sealing temperatures.

FIG. 1a) presents a diagrammatic view of the structure of two sealing partners 1, 2 and the arrangement of a thermocouple 3 for measuring the interface temperature at the interface between the sealing partners 1, 2 during the sealing process. In the embodiment shown, the sealing partners 1, 2 have an identical structure. They each consist of an outer layer made of polyethylene-terephthalate (PET) 4, a middle layer 5 made of an aluminum material, and a sealing layer 6 made out of polyethylene (PE).

During the sealing process, the two sealing partners 1, 2 are pressed together by means of sealing tools (not shown). The sealing tools having a temperature T, and are pressed together with pressure p for time t, or based on a T, P, t program with variable-time temperature and/or variable-time pressure. The temperature T, pressure p and time t or a T, P, t program can be set within prescribed limits depending on the respective sealing device.

In order to record the interface temperature progression necessary for realizing the invention, the thermocouple 3 is located between the polyethylene layers 6 of both sealing partners 1, 2 during the entire sealing process. After the measuring process, the thermocouple 3 is hence also sealed into the cooled sealing seam. As a consequence, the progression of the interface temperature can only be measured for a temperature-measuring element designed as a thermocouple 3 during one or numerous sealing processes executed outside the actual production process, but using the machines used for production on-site, and exclusively for purposes of recording these progressions. However, this is sufficient for obtaining the information required to improve the machining sequence. The other sealing machines used in regular production must only permit the introduction of thermocouples between the sealing tools, and allow the transfer of measuring results, e.g., via a trailing cable or telemetry.

FIG. 1b) presents a second embodiment with two alternative sealing partners 7, 8, which exhibit a different layer structure. Sealing partner 7 consists of a layer of aluminum material 9, a polyethylene-terephthalate (PET) layer 10 and a sealing varnish layer 11. The second sealing partner 8 is made completely of polypropylene (PP) 12 in the second embodiment.

The embodiment shown on FIG. 1a) shows the constellation while sealing laminates, e.g., during the manufacture of stand-up-pouches, while the embodiment shown on FIG. 1b) shows the manufacture of a sealing seam for connecting a tear-off lid with a cup.

FIG. 2 presents a graph without markers to show the time-temperature curve of heat input over two sealing jaws, a graph with triangular markers to show the measuring points of the time-temperature progression for the interface temperature at the interface of an aluminum (30 μm)/hot-sealing varnish laminate as a first sealing partner, and polypropylene (PP) as the second sealing partner, and a graph with rhombic markers to show the measuring points of the time-temperature progression of the interface temperature at an interface between an aluminum/polyethylene-terephthalate/hot-sealing varnish laminate as the first sealing partner, and polypropylene (PP) as the second sealing partner. The time-temperature curve of heat input is preferably recorded at the inputs of the measuring equipment hooked up to the sealing machine. As particularly evident in this depiction, the interface temperature progression must be measured during and after heat input during hot sealing to obtain complete information about the sealing process. In both cases, the highest interface temperature is only reached clearly after heat input is complete. In both cases, the integral of the time-temperature progression of the interface temperature between the point at which the temperature exceeds the melting temperature and falls below the solidification temperature yields valuable data about the quality of the fabricated hot-sealing seam.

FIG. 3 uses graphs with square, triangular and rhombic markers to initially show the progression over time of heat input. Heat input took place in the three tests shown on FIG. 3 over the course of 1.5 seconds at a jaw temperature of 160, 140 and 130° C. The respective accompanying time-temperature progression of the interface temperature is also evident from graphs, which have square, triangular and rhombic markers. All three measuring curves relate to the progression of the interface temperature at the interface between a polyethylene-terephthalate (12 μm)/aluminum (9 μm)/polyethylene-terephthalate (70 μm) laminate as the first and second sealing partner.

As also evident from the measuring curves shown on FIG. 3, the maximal interface temperature is only reached quite a long time after heat input is complete. Here as well, the integral of the time-temperature progression of the interface temperature between the point at which the temperature exceeds the melting temperature and falls below the solidification temperature provides useful information about the achieved sealing quality. Additional information can be obtained in the depicted measuring curves from the flattening of the cooling progression as the result of recrystallization, although this cannot be observed for each sealing material. Such a flattening cannot be observed in the measuring curve marked with rhombi owing to missing or insignificant recrystallization. It may here be assumed that the sealing layers have not been sufficiently melted on to establish a permanent sealing bond. By contrast, the measuring curve with triangles clearly reveals a flattening 13, so that extensive recrystallization, and hence good sealing seam quality, can be concluded. The measuring curve with squares only reveals a slightly elevated flattening 14, so that it may be concluded that the sealing seam quality cannot be significantly improved by a sealing jaw temperature increased to 160° C. However, a comparison of the latter two curves also shows that solidification at a sealing jaw temperature of 160° C. takes place about two seconds later than at a sealing jaw temperature of 140° C., so that the anticipated optimal sealing jaw temperature lies in the 140° C. range in this embodiment, since good sealing quality is here ensured, while the “hot-tack” time is reached early.

The extent or time of recrystallization can be determined more precisely from the first or second differential function of measuring curves via the determination of maximums or zero crossings than from the depicted measuring curves as such. These first or second differential functions can be established with no outlay in EDP systems, which are routinely used to record such measuring curves.

For the sake of completeness, it must be mentioned that the measuring signal of the thermocouple secured between the sealing partners on the interface is recorded by an analog/digital converter, and transformed into a digital signal, which is acquired by a measuring and evaluation program installed on a portable EDP system, for example. These types of systems constitute part of prior art.

What is claimed is:

1. A method for setting a process for the manufacture of sealing seams, in which the interface temperature at the interface between the sealing partners is measured using a temperature measuring element, characterized in that the process is set based on the course of time of the interface temperature during and after heat input during the sealing.

2. The method according to claim 1, characterized in that the time-temperature-pressure progression during heat input is set.

3. The method according to claim 1 or 2, characterized in that the time for the tightness check and/or the mechanical loadability after heat input is set.

4. The method according to one of claims 1 to 3, characterized in that the point at which the interface temperature exceeds the melting temperature of at least one sealing layer of the sealing is monitored during heat input.

5. The method according to one of claims 1 to 4, characterized in that the integral of the time-temperature progression of the interface temperature is determined between the point where the temperature exceeds the melting temperature and falls below the solidification temperature of at least one sealing layer of the sealing partners.

6. The method according to one of claims 1 to 5, characterized in that the time at which the interface temperature falls below the melting temperature of at least one sealing layer of the sealing partners is determined.

7. The method according to one of claims 1 to 6, characterized in that the recrystallization of at least one sealing layer can be determined from a reduction in the cooling rate after heat input is complete.

8. The method according to claim 7, characterized in that the recrystallization time is determined.
